(19) United States
(12) Patent Application Publication
(10) Pub. No.: US 2016/0146957 A1
(43) Pub. Date: May 26, 2016

(54) SYSTEMS AND METHODS FOR DISTRIBUTED SEISMIC RECORDING AND ANALYSIS

(71) Applicant: CGG Services SA, Massy Cedex (FR)

(72) Inventors: Peter Maxwell, Missouri City, TX (US); Ray Sutyla, Katy, TX (US); Ralph Fraile, Alberta (CA)

(21) Appl. No.: 14/946,463

(22) Filed: Nov. 19, 2015

Related U.S. Application Data
(60) Provisional application No. 62/084,927, filed on Nov. 26, 2014.

(51) Int. Cl. G01V 1/22; E21B 47/00; E21B 43/26; G01V 1/26; G01V 1/30

(52) U.S. Cl. CPC G01V 1/223; G01V 1/26; G01V 1/308; E21B 43/26; E21B 47/00; G01V 2210/612

(57) ABSTRACT

The present disclosure includes a data acquisition method for seismic exploration and monitoring including generating a time reference for an acquisition unit. The time reference defines a time window in the future. The method further includes transmitting the time reference to the acquisition unit. After the time window has elapsed, receiving a record of a seismic event measured during the time window.

### CROSS-REFERENCE TO RELATED APPLICATION

This application claims the benefit under 35 U.S.C. §119(e) of U.S. Provisional Application Ser. No. 62/084,927 filed on Nov. 26, 2014, entitled “Systems and Methods for Distributed Seismic Recording and Analysis,” which is incorporated by reference in its entirety for all purposes.

### TECHNICAL FIELD

The present disclosure relates to the field of seismic data acquisition. In particular, the present disclosure relates to a seismic acquisition by a meshed network of acquisition units and distributed seismic recording and analysis.

### BACKGROUND

Seismic surveying or seismic exploration, whether on land or at sea, is accomplished by observing a seismic signal that propagates through the earth. Propagating seismic energy is partially reflected, refracted, diffracted and otherwise affected by one or more geologic structures within the earth, for example, by interfaces between underground formations having varying acoustic impedances. The affected seismic energy is detected by seismic receivers, also referred to as “seismic detectors,” placed at or near the earth's surface, in a body of water, or down hole in a wellbore. Seismic receivers convert the displacement of the ground resulting from the propagation of the waves into an electrical signal. The resulting electrical signals are recorded and processed to generate information relating to the physical properties of subsurface formations.

Seismic exploration may be active seismic exploration where a controlled seismic source emits a seismic signal for the purpose of seismic exploration. Active seismic sources include seismic vibrators, explosives (including dynamite), air guns, water guns, thumper trucks, or piezoelectric sources. Active seismic sources may produce a seismic signal from known locations and the active seismic sources may produce those signals at known times.

Some seismic exploration or monitoring may be done passively, or in other words, without generating a seismic signal explicitly for the purpose of recording the response. One example of passive seismic monitoring includes monitoring for seismic signals associated with microseismic events. In addition to naturally induced microseismic events, microseismic events may be caused by human operations. This may include any circumstance in which human action changes the stress fields within geological structures in the earth. Some examples include hydraulic fracturing, also referred to as hydrofracturing or “fracking,” perforation shots, string shots, damming a water flow (for example, a river or stream), heating the ground, cooling the ground, mining, downhole events such as, drilling, and injecting water or other liquid to displace oil or gas.

The seismic signal in active or passive seismic exploration is emitted in the form of a wave that is reflected from interfaces between geological layers. As such, seismic exploration may involve the creation of P-waves (primary waves) and S-waves (secondary or shear waves). Microseismic events generate P-waves and S-waves, which are received at seismic receivers. A P-wave is an elastic body wave or sound wave in which particles oscillate in the direction the wave propagates. P-waves incident on an interface at other than normal incidence can produce reflected and transmitted S-waves, otherwise known as converted waves.

An S-wave, generated by most land seismic sources and sometimes as converted P-waves, is an elastic body wave in which particles oscillate perpendicular to the direction in which the wave propagates. S-waves travel more slowly than P-waves and cannot travel through fluids because fluids do not support shear. In some circumstances, S-waves may be converted to P-waves. Recording of S-waves requires receivers coupled to the earth's surface and their interpretation can allow determination of rock properties such as fracture density and orientation, Poisson's ratio, and rock type by cross-plotting P-wave and S-wave velocities and other techniques.

The reflected waves are received by an array of seismic receivers. A seismic trace is the seismic data recorded by a seismic receiver. The seismic trace represents the response of the elastic wave field to velocity and density contrasts across interfaces of layers of rock or sediments as energy travels from the seismic source through the subsurface to a receiver or receiver array.

Active and passive seismic monitoring are sometimes performed over time. This type of analysis is referred to as “time-lapse” or “4D” monitoring. Permanent Reservoir Monitoring (PRM) or Continuous Reservoir Monitoring (CRM) is used to perform 4D monitoring near a reservoir over an extended period of time, though such implementations need not be permanent or continuous. In addition to an image of subsurface formations, 4D monitoring can provide information as to how seismic waves interact with subsurface formations over time, or how the subsurface formations and their contents may change over time. For example, as a producing well is depleted, the introduction of water to displace oil or gas may cause a change in the way seismic waves interact with the subsurface formations. As another example, fractures are formed during hydraulic fracturing and the progress and quantity of these fractures can be monitored over time. These fractures may occur along a fault plane.

The passive seismic monitoring of fault planes can be advantageous in a variety of circumstances. For example, passive seismic monitoring can indicate the origin time, location, and magnitude of earthquakes. Passive seismic monitoring for microseismic events can be used to estimate the location and orientation of a fault plane where smaller fractures have occurred. Determining the location and orientation of a fault plane can provide insight into subsurface formations, including potential traps for oil and gas. A fault may move porous reservoir rock, such as sandstone or limestone, against an impermeable seal, such as shale or salt. If the fault does not leak, oil or gas can pool in the reservoir rock. Additionally, the formation and propagation of fractures by the creation of small slip planes can be beneficial when monitoring the progress of hydraulic fracturing. By monitoring the formation of fractures in hydraulic fracturing, practitioners can recognize when sufficient hydraulic fracturing has been completed or whether more fluid needs to be pumped into the fracturing well.

Well enhancement operations, such as hydraulic fracturing, cause microseismic events in the subsurface formation that may be detected by seismic receivers located elsewhere, such as at the earth's surface. During hydraulic fracturing operations or other circumstances where human action changes stress fields within geological structure, microfractures generated in the layer induce micro-earthquakes that are propagated and can be detected by means of seismic receivers.

Stimulation hydraulic fracturing operations are intended to increase the productivity of a hydrocarbon reservoir working well. These operations consist of injecting a high-pressure fluid into a layer of the subsurface formation where the hydrocarbon reservoir is located. The injection of the fluid produces microfractures in the layer. This technique makes it possible to increase the permeability of the hydrocarbon reservoir by providing hydrocarbon circulation via the microfractures to the well. However, stimulation hydraulic fracturing operations may include continuous monitoring of the hydrocarbon reservoir to monitor the progress of the hydraulic fracturing operation and terminate the fracturing operation when the hydraulic fracturing is sufficient.

Conventional seismic acquisition relies on timing of signals relative to a known time reference, which is referred to as t0, “t-zero,” or “time zero.” This known time reference is a system-wide reference time that normally corresponds to the time when the seismic source is initiated. For example, t0 may represent the time that a charge is detonated to generate a seismic signal. At a seismic receiver or recorder, the record runs onwards from this time showing the received signal relative to t0. In conventional seismic acquisitions systems, t0 is known based on when, for example, a charge is detonated or when a seismic source at the surface, such as a thumper truck, begins a seismic sweep.

Analysis of active seismic exploration differs from the analysis of passive seismic exploration, such as seismic signals generated by well enhancement operations, or microseismic events. In the case of monitoring microseismic events, there may not be a known t0. In the case of detecting and analyzing microseismic events, recording may be performed continuously. For example, seismic receivers and associated hardware may record seismic activity continuously. The continuously-measured data, along with a file of later-generated t0 times, can then be used to output the appropriate signals for the microseismic events. This post-acquisition methodology has a drawback because a large amount of data is downloaded at once. It is desirable to download the data from the seismic receivers and associated hardware rapidly, so that the data can be used to monitor an ongoing hydraulic fracturing operation or other subsurface operation. If there are a large number of seismic receivers and associated hardware connected by a mesh network, bandwidth constraints of the mesh network may slow the retrieval of data from the seismic receivers.

### SUMMARY

In some embodiments, a data acquisition method for seismic exploration includes generating a time reference for an acquisition unit. The time reference defines a time window in the future. The method further includes transmitting the time reference to the acquisition unit. After the time window has elapsed, receiving a record of a seismic event measured during the time window.

In another embodiment, an acquisition unit for seismic exploration includes a seismic receiver configured to generate a signal in response to a sensed seismic event. The acquisition unit further includes a processor and a network interface. The acquisition unit includes a memory configured to store data based on the signal generated by seismic receiver. The memory also stores executable instructions that, when executed by the processor, cause the processor to receive a time reference. The time reference defines a time window in the future. The executable instructions further cause the processor to measure a property associated with the seismic event during the time window to generate a record associated with the time window. The executable instructions further cause the processor to transmit the record associated with the time window to a first data collection unit after the time windows has elapsed.

In another embodiment, a data acquisition system for seismic exploration includes a first data collection unit. The first data collection unit includes a network interface, a processor, and a memory. The memory includes executable instructions that, when executed, cause the processor to generate a time reference for a first plurality of acquisition units. The time reference defines a time window in the future. The executable instructions further cause the processor to transmit the time reference to the first plurality of data acquisition units. The executable instructions further cause the processor to receive, from the plurality of first data acquisition units, a plurality of records of a seismic event during the time window.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates a block diagram of an example system for microseismic monitoring in accordance with some embodiments of the present disclosure;

FIG. 2 illustrates a block diagram of an example acquisition unit in accordance with some embodiments of the present disclosure;

FIG. 3 illustrates a block diagram of an example temporary data collection unit in accordance with some embodiments of the present disclosure;

FIG. 4 illustrates a block diagram of an example central data collection unit in accordance with some embodiments of the present disclosure;

FIG. 5 illustrates a flow chart for example methods of operation for the acquisition unit in accordance with some embodiments of the present disclosure;

FIG. 6 illustrates a flow chart for example methods of operation for the temporary data collection unit in accordance with some embodiments of the present disclosure; and

FIG. 7 illustrates a flow chart for example methods for monitoring a well enhancement operation in accordance with some embodiments of the present disclosure.

### DETAILED DESCRIPTION

Systems and methods disclosed herein may monitor and analyze microseismic events in subsurface formations. The systems and methods may be used to monitor the progress of well enhancement operations in subsurface formations. The systems and methods may measure microseismic events including generating a set of future time references defining time windows for a plurality of acquisition units. The time references define recording time windows in the future. The systems and methods may include transmitting the set of time references to the acquisition units, which may include a seismic receiver and associated hardware. The systems and methods may include, at one or more acquisition units, measuring a property associated with the microseismic events during one of the recording time windows and generating a record associated with the time window. The systems and methods may further include, at one or more acquisition units, transmitting the record associated with the time window from the acquisition unit to a first data collection unit after the time window has elapsed.

Such systems and methods may alleviate the drawbacks of currently used methods and may provide improved methods for collecting and analyzing microseismic data from arrays of seismic receivers. Moreover, the systems and methods disclosed herein may be used to monitor operations in the subsurface formation in real-time.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

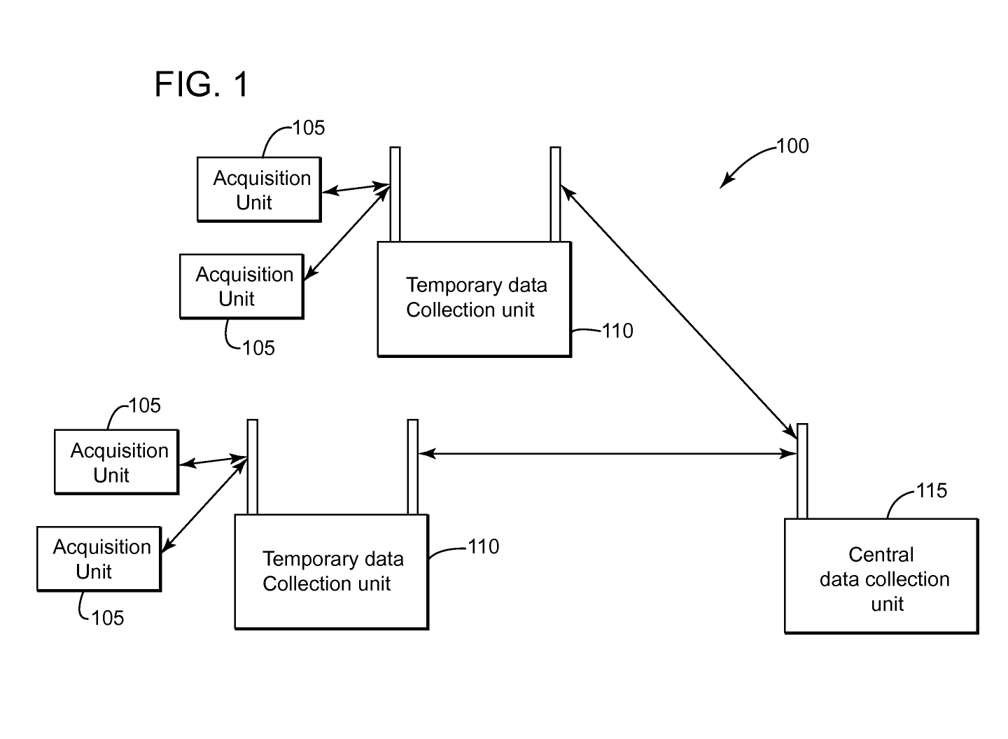

FIG. 1 illustrates a block diagram of an example system 100 for microseismic monitoring. A plurality of acquisition units 105 are placed at selected locations to monitor microseismic activity caused, for example, by a well enhancements operation. In some embodiments, acquisition units 105 are placed at selected locations to monitor a hydraulic fracturing operation. Acquisition units 105 may be arranged into one or more “patches” of acquisition units 105, with each patch of acquisition units 105 placed over a region of interest. Each patch may include any number of acquisition units 105. For example, in some embodiments, each patch includes forty-eight acquisition units 105. In some embodiments, one or more patches include twenty-four acquisition units 105, any number from two to twenty-four acquisition units 105, or more than forty-eight acquisition units 105. Each patch may include the same number of acquisition units 105 or different numbers of acquisition units 105.

Each of acquisition units 105 is associated with a temporary data collection unit 110, as shown in FIG. 1. In some embodiments, acquisition units 105 detect and record seismic data continuously. At certain times, acquisition unit 105 transmits some or all of the recorded seismic data to its associated temporary data collection unit 110. In some embodiments, one or more acquisition units 105 communicate with an associated temporary data collection unit 110 by a wireless networking connection. In certain embodiments, one or more acquisition units 105 communicate with an associated temporary data collection unit 110 by a wired networking connection. At various times, the temporary data collection units 110 may poll associated acquisition units 105 for data collected by the acquisition units 105. In some embodiments, the temporary data collection units 110 form a mesh network to communicate with each other and with central data collection unit 115. In some embodiments, the connection between temporary data collection units 110 and central data collection unit 115 is a wired connection to increase the available bandwidth.

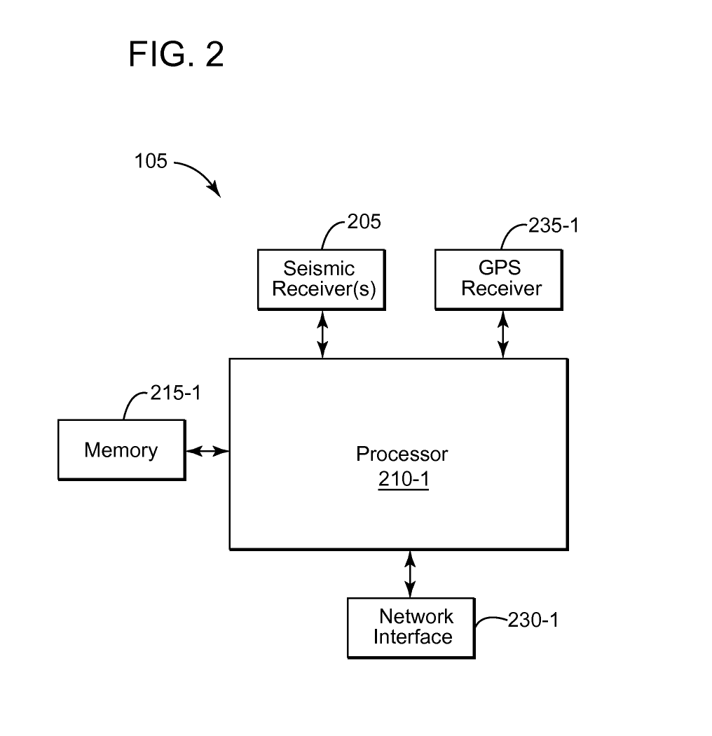

FIG. 2 illustrates a block diagram of an example acquisition unit 105. Example acquisition unit 105 includes one or more seismic receivers 205. Seismic receivers 205 may be located on or proximate to the surface of the earth within an exploration area or a within a monitoring area. Seismic receivers 205 may be any type of instrument that is configured to transform seismic energy or vibrations into an electrical signal. For example, seismic receivers 205 may be hydrophones or geophones. As other examples, seismic receivers 205 may be vertical, horizontal, or multicomponent geophones, accelerometers, or optical fibers with wire or wireless data transmission, such as three component (3C) geophones, 3C accelerometers, 3C Digital Sensor Units (DSU), or a set of distributed acoustic sensors (DAS). In some embodiments, a plurality of seismic receivers 205 are utilized to provide data related to multiple locations. Seismic receivers 205 may be positioned in a plurality of configurations, such as linear, grid, array, or any other suitable configuration. In some embodiments, seismic receivers 205 are positioned along one or more strings. Each seismic receiver 205 may be spaced apart from adjacent seismic receivers 205 in the string. Spacing between seismic receivers 205 in string may be approximately the same preselected distance, or span, or the spacing may vary depending on a particular application, exploration area topology, or any other suitable parameter. One or more seismic receivers 205 may transmit raw seismic data to processor 210-1.

Acquisition unit 105 further includes processor 210-1. Processor 210-1 is in communication with and communicatively coupled to memory 215-1 and network interface 230-1. In some embodiments, processor 210-1 is further in communication with and communicatively coupled to global positioning system (GPS) receiver 235-1.

Processor 210-1 executes instructions, codes, computer programs, and scripts accessed from memory 215-1 or network interface 230-1. While only one processor 210-1 is shown, multiple processors 210-1 may be present. Thus, while instructions may be discussed as executed by a processor, the instructions may be executed simultaneously, serially, or otherwise executed by one or multiple processors. Instructions, codes, computer programs, scripts, or data accessed from memory 215-1 or network interface 230-1 may be referred to in some contexts as non-transitory instructions, media, or information. Processor 210-1 includes any hardware or software that operates to control and process information. In some embodiments, processor 210-1 may be a programmable logic device, a microcontroller, a microprocessor, central processing unit (CPU), any suitable processing device, or any suitable combination of the preceding. Further, processor 210-1 may comprise an internal random access memory (RAM), read only memory (ROM), a cache memory, or other internal non-transitory storage blocks, sections, or components that may be referred to in some contexts as non-transitory computer readable media or computer readable storage media.

In some embodiments, memory 215-1 stores either permanently or temporarily, data, operational software, or other information for processor 210-1, seismic receiver 205-1, or other components of acquisition unit 105. Memory 215-1 includes any one or a combination of volatile or nonvolatile local or remote devices suitable for storing information. For example, memory 215-1 may include RAM, ROM, flash memory, magnetic storage devices, optical storage devices, network storage devices, cloud storage devices, solid-state devices, external storage devices, any other suitable information storage device, or a combination of these devices. Memory 215-1 may store information in one or more databases, file systems, tree structures, any other suitable storage system, or any combination thereof. Furthermore, different types of information stored in memory 215-1 may use any of these storage systems. Additionally, any information stored in memory may be encrypted or unencrypted, compressed or uncompressed, and static or editable. Acquisition unit 105 may have any suitable number, type, or configuration of memory 215-1. Memory 215-1 may include any suitable information for use in the operation of acquisition unit 105. For example, memory 215-1 may store measurements from the one or more seismic receivers 205 and corresponding times from GPS receiver 235-1. Memory 215-1 may be referred to in some contexts as computer readable storage media or non-transitory computer readable media.

Network interface 230-1 represents any suitable device operable to receive information from or transmit information to temporary data collection unit 110 or other acquisition units 105, perform suitable processing of information, communicate with other devices, or any combination thereof. In some embodiments, network interface 230-1 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), or other air interface protocol radio transceiver cards, and other network devices. Network interface 230-1 may include any port or connection, real or virtual, including any suitable hardware or software (including protocol conversion and data processing capabilities) that communicates through a communication system. In some embodiments, network interface 230-1 in acquisition unit 105 creates a wireless data connection with a network interface 230-2 in temporary data collection unit 110. Acquisition unit 105 may have any suitable number, type, or configuration of network interface 230-1.

Network interface 230-1 may enable processor 210-1 to communicate with the Internet or one or more intranets. With such a network connection, processor 210-1 may receive information from the network, or might output information to the network in the course of performing the described method steps. Such information, which is often represented as a sequence of instructions to be executed using processor 210-1, may be received from and outputted to the network, for example, in the form of a computer data signal embodied in a carrier wave.

Such information, which may include data or instructions to be executed by processor 210-1, may be received from and outputted to the network, for example, in the form of a baseband signal or signal embodied in a carrier wave. The baseband signal or signal embodied in the carrier wave generated by the network interface 230-1 may propagate in or on the surface of electrical conductors, in coaxial cables, in waveguides, in an optical conduit, for example an optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, may be generated according to several methods well known to one skilled in the art. The baseband signal or signal embedded in the carrier wave may be referred to in some contexts as a transitory signal. In some embodiments, acquisition unit 105 further includes a positioning system, such as GPS receiver 235-1. GPS receiver 235-1 may be utilized to locate or time-correlate acquisition units 105. GPS receiver 235-1 allows the acquisition unit 105 to maintain accurate time. In some embodiments, the acquisition unit 105 includes an alternative clock to determine the current time. GPS receiver 235-1 may transmit a signal that is indicative of the current time to the processor 210-1.

In some embodiments, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by processor 210-1, at least portions of the contents of the computer program product to memory 215-1, or to other non-volatile memory and volatile memory. Processor 210-1 may process the executable instructions or data structures in part by directly accessing the computer program product. Alternatively, processor 210-1 may process the executable instructions or data structures by remotely accessing the computer program product, for example by downloading the executable instructions or data structures from a remote server through the network interface 230-1. The computer program product may comprise instructions that promote the loading or copying of data, data structures, files, or executable instructions to memory 215-1.

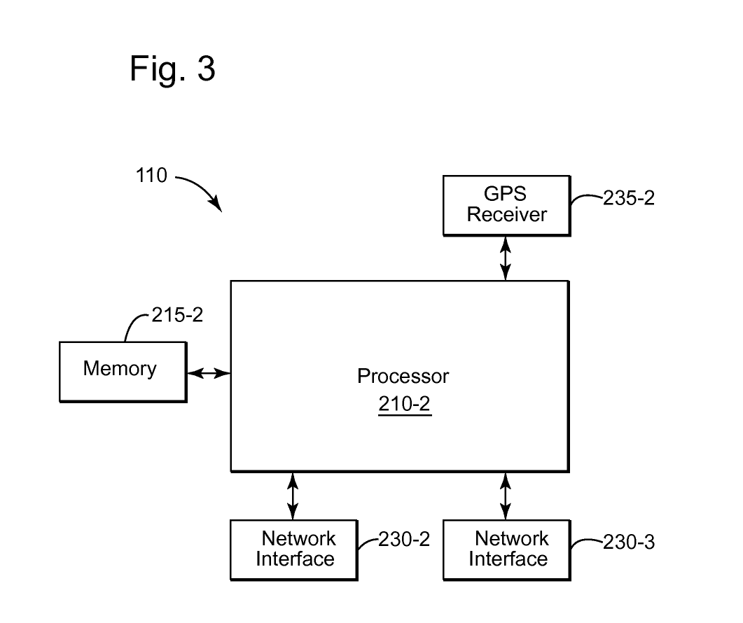

FIG. 3 is block diagram of an example temporary data collection unit 110. Temporary data collection unit 110 includes processor 210-2, memory 215-2, first network interface 230-2, and GPS receiver 235-2. In some embodiments, temporary data collection unit 110 further includes second network interface 230-3. Processor 210-2, memory 215-2, network interfaces 230-2 and 230-3, and GPS receiver 235-2, respectively, may be similar to processor 210-1, memory 215-1, network interface 230-1, and GPS receiver 235-1 discussed with reference to FIG. 1, respectively.

In some embodiments, second network interface 230-3 connects temporary data collection unit 110 with a mesh wireless network of two or more temporary data collection units 110. In some embodiments, second network interface 230-3 is used to communicate with central data collection unit 115 via a wireless or wired network, such as by using cable data transfer or a fiber-optic data transfer. In some embodiments, temporary data collection unit 110 may perform all networking functionality with first network interface 230-2.

In some embodiments, temporary data collection units 110 acts as a wireless access point for two or more acquisition units 105, other temporary data collection units 110, or central data collection unit 115. In some embodiments, one temporary data collection unit 110 is for a patch of acquisition units 105. In some embodiments, the acquisition units 105 are configured so that acquisition units 105 communicate with a nearby temporary data collection unit 110, rather than a more distant temporary data collection unit 110. Each temporary data collection unit 110 receives and compiles records from associated acquisition units 105 and then transmits the records to the central data collection unit 115. Example temporary data collection units 110 further generate one or more time references that define time windows in the future for one or more associated acquisition units 105. Example temporary data collection units 110 transmit the future time references to the associated acquisition units 105. By limiting which acquisition units 105 communicate with a particular temporary data collection unit 110, data flow in the network of acquisition units 105 and temporary data collection units 110 may be managed.

In some embodiments, temporary data collection unit 110 includes sufficient processing capability to perform processing of the records from the acquisition units 105 before transmitting the compiled records to central data collection unit 115. For example, temporary data collection unit 110 stacks data records from multiple acquisition units 105 for the same time windows and then transmits the stacked records to central data collection unit 115. As another example, temporary data collection unit 110 filters data records from multiple acquisition units 105 for the same time windows and then transmits the filtered records to central data collection unit 115. Data processing by temporary data collection units 110 may reduce the amount of data transmitted between temporary data collection units 110 and central data collection unit 115. In some embodiments, the processing of seismic data is performed faster by distributing at least some of the processing effort across temporary data collection units 110.

In some embodiments, temporary data collection units 110 may have additional options for transmitting data to central data collection unit 115. For example, temporary data collection units 110 may include an access port to connect a device that collects data from temporary data collection units 110. The data collection device may then be physically transported to central data collection unit 115 where the records on the data collection device are downloaded.

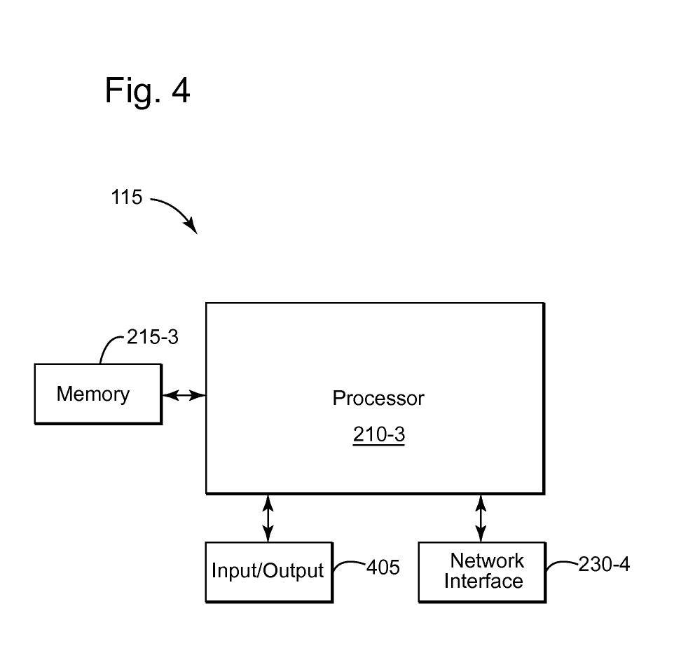

FIG. 4 illustrates a block diagram of an example central data collection unit 115. Central data collection unit 115 includes processor 210-3, memory 215-3, and network interface 230-4. Processor 210-3, memory 215-3, and network interface 230-4, respectively, may be similar to processor 210-1, memory 215-1, and network interface 230-1, discussed with reference to FIG. 1, respectively.

In some embodiments, central data collection unit 115 may include two or more computing systems in communication with each other that collaborate to perform a task. For example, but not by way of limitation, an application may be partitioned in such a way as to permit concurrent or parallel processing of the instructions of the application. Alternatively, the data processed by the application may be partitioned in such a way as to permit concurrent or parallel processing of different portions of a data set by the two or more computers. In some embodiments, virtualization software may be employed by central data collection unit 115 to provide the functionality of a number of servers that is not directly bound to the number of computers in central data collection unit 115. For example, virtualization software may provide twenty virtual servers on four physical computers. In some embodiments, the functionality disclosed above may be provided by executing the application or applications in a cloud-computing environment. Cloud computing may comprise providing computing services via a network connection using dynamically scalable computing resources. Cloud computing may be supported, at least in part, by virtualization software. A cloud-computing environment may be established by an enterprise or may be hired on an as-needed basis from a third party provider. Some cloud computing environments may comprise cloud computing resources owned and operated by the enterprise as well as cloud computing resources hired or leased from a third party provider. In some embodiments, central data collection unit 115 may be included in a computing system operable to perform multiple operations related to seismic exploration and monitoring, such as executing well enhancement operations and monitoring the results of such operations.

In some embodiments, network interface 230-4 is used to communicate with temporary data collection units 110 via a wireless or wired network, such as by using cable data transfer or a fiber-optic data transfer. In some embodiments, central data collection unit 115 may include an access port to connect a device that collects data from temporary data collection units 110. The data collection device may then be physically transported to central data collection unit 115 where the records on the data collection device are downloaded.

Central data collection unit 115 may further include input/output 405. Input/output 405 may include one or more monitors, keyboards, mice, or other input and output devices. Central data collection unit 115 may be configured to display information based on the collected seismic measurements to a user. Central data collection unit 115 may be further configured so that a user can terminate or alter a well enhancement operation, such as a hydraulic fracturing operation, by using input/output 405.

In some embodiments, central data collection unit 115 is a recording system for recording records from temporary data collection units 110. An example central data collection unit 115 generates the final records of the microseismic activity from all of the acquisition units 105. In some embodiments, the collected data is transferred to another device for further processing.

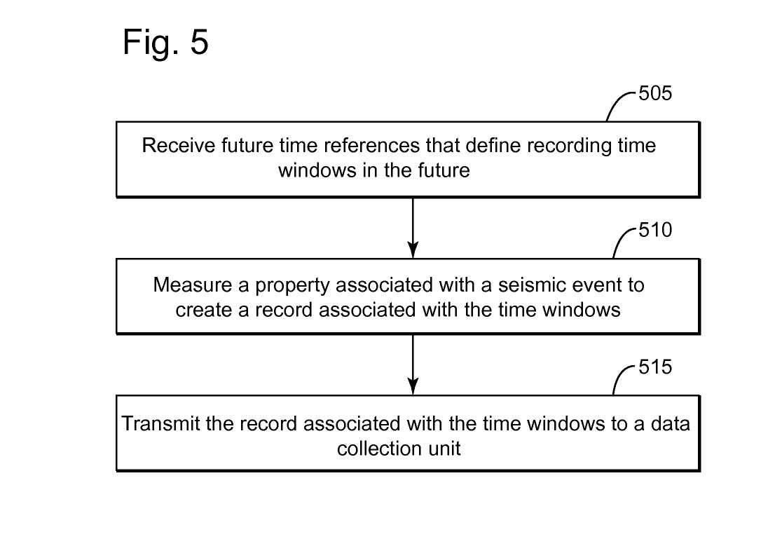

FIG. 5 illustrates a flow chart for example methods of operation for acquisition unit 105. The steps of method 500 are performed by a user, various computer programs, models configured to detect, receive, and process seismic data, and combinations thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to detect, receive, and process seismic data may be referred to as an “acquisition unit.” For illustrative purposes, method 500 is described with respect to data based on acquisition unit 105 of FIGS. 1 and 2.

In some embodiments, acquisition unit 105 continuously records detected or measured seismic activity from when acquisition unit 105 is powered-up to when acquisition unit 105 is powered-down. In some embodiments, acquisition unit 105 is pragmatically placed into a stand-by mode during times when no activity is expected. For example, acquisition unit 105 may be placed in a stand-by mode at night or while a subsurface operation is not scheduled to occur.

In block 505, the acquisition unit 105 receives one or more future time references that define time windows in the future. The future time references are selected to divide the data recoding times for acquisition unit 105 into portions that may be transmitted to temporary data collection unit 110. As discussed above, in some embodiments, each acquisition unit 105 is in communication with one temporary data collection unit 110. In some embodiments, the one or more future time references is generated by the temporary data collection unit 110 that is associated with the acquisition unit 105. These future time references may include a list of t0 values that define time windows.

In block 510, using the one or more seismic receivers 205, the acquisition unit 105 measures a property, for example seismic activity, associated with a seismic event and the acquisition unit 105 creates a record of the property for one of the time windows. Example events are microseismic events associated with subterranean operations. Other example events include events associated with one or more of passive monitoring, active monitoring, 3D seismic monitoring, or 4D seismic monitoring. In some embodiments, the record is stored as data in memory 215-1. The acquisition unit 105 associates the measured property with a time window based on the time from the GPS receiver 235 or from another clock.

In block 515, after a particular time window has elapsed, the acquisition unit 105 transmits the data associated with the particular time window to the temporary data collection unit 110. In some embodiments, temporary data collection unit 110 may poll or request data for acquisition unit 105.

In some embodiments, by providing future time references to the acquisition unit 105, the amount of data transmitted between acquisition unit 105 and temporary data collection unit 110 is managed. For example, in some embodiments, the length of the time window is longer than the time required for acquisition unit 105 to transmit data for the preceding time window to the temporary data collection unit 110. In some embodiments, the length of the time windows is chosen so that all acquisition units 105 associated with a given temporary data collection unit 110 are able to transmit data for a previous time window during a current time window. As such, the network may avoid being swamped by acquisition units 105 transmitting large amounts of data to their associated temporary data collection unit 110.

The process illustrated in FIG. 5 is repeated to monitor the progress of a well enhancement operation, such as a hydraulic fracturing operation. In some example operations, the process of FIG. 5 is repeated for hours or days, depending on the length of the operation.

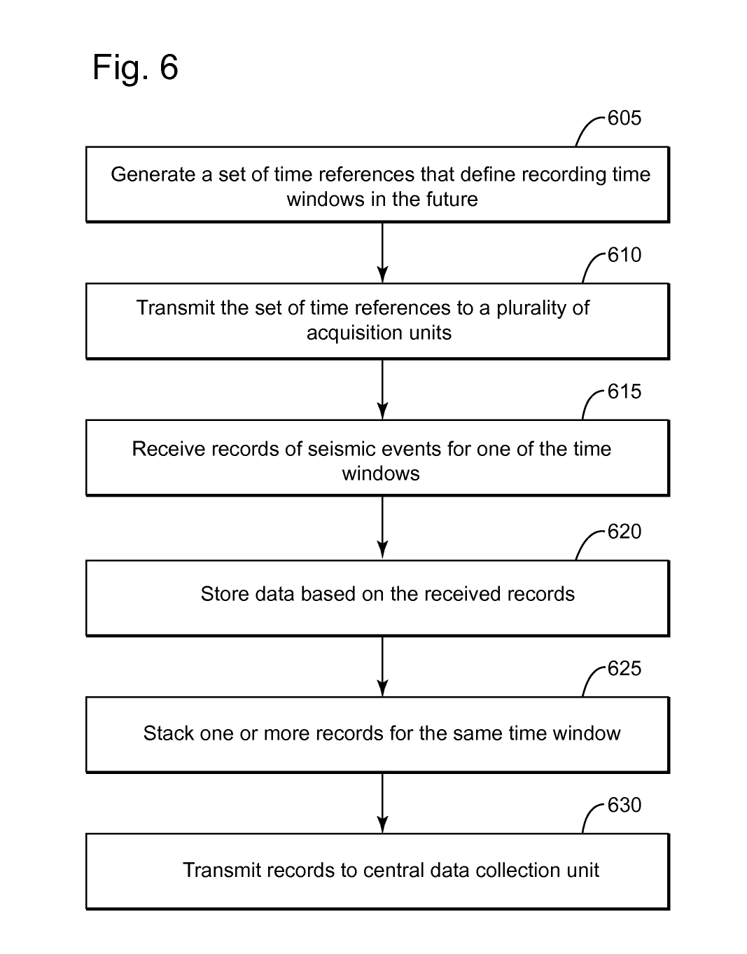

FIG. 6 illustrates a flow chart for example methods of operation for temporary data collection unit 110. The steps of method 600 are performed by a user, various computer programs, models configured to receive, process, and analyze seismic data, and combinations thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to receive, process, and analyze seismic data may be referred to as a “temporary data collection unit.” For illustrative purposes, method 600 is described with respect to data based on temporary data collection unit 110 of FIGS. 1 and 3. Example embodiments may omit one or more of blocks 605 through 630. Other example embodiments may include additional blocks. Still other embodiments may perform blocks 605 through 630 in a different order from that shown in FIG. 6.

In block 605, temporary data collection unit 110 generates one or more future time references that define time windows in the future. Temporary data collection unit 110 performs block 605 for each acquisition unit 105 that is associated with the temporary data collection unit 110. Example time windows are sixty seconds, thirty seconds, fifteen seconds, or ten seconds. Other example time windows may be several minutes.

In block 610, temporary data collection unit 110 transmits the one or more future time references for each acquisition unit 105 to the acquisition unit 105. Transmission may be accomplished using network interface 230-2.

In block 615, after each time window elapses, temporary data collection unit 110 receives records of seismic activity from acquisition unit 105. As discussed above, in some embodiments, the seismic activity may include microseismic activity, which is passive seismic activity of low magnitude. Example passive seismic activity may be caused by natural phenomena, such as earthquakes or volcanic eruptions. Example passive seismic activity may be caused by man-made sources, such as noise from factories, vehicular motion, drilling, or well-enhancement operations, such as hydraulic fracturing, propping a formation, or steam injection. In some embodiments, the seismic activity is active seismic activity. In these embodiments, acquisition unit 105 may be configured to measure and record active seismic activity and on command output or transmit the measured seismic activity immediately or after a time interval has elapsed. In some embodiments, the seismic activity is a combination of active and passive seismic activity.

In block 620, temporary data collection unit 110 stores data based, at least in part, on the received records from acquisition unit 105. In certain example embodiments, the records are stored in memory 215-2.

Example temporary data collection units 110 may perform processing of the records of seismic activity from the acquisition units 105 before transmitting the records to the central data collection unit 115. For example, in block 625, the temporary data collection unit 110 stacks records of seismic activity for the same time window from two or more acquisition units 105 before transmitting the stacked records to central data collection unit 115. In some embodiments, temporary data collection unit 110 applies filters to the records of seismic activity from acquisition units 105 before transmitting the filtered records to central data collection unit 115. In some embodiments, however, temporary data collection unit 110 compiles the records of seismic activity from acquisition units 105 for a time window and then transmits the compiled records for the time window to central data collection unit 115. In block 630, temporary data collection unit 110 transmits records to central data collection unit 115.

In some embodiments, the temporary data collection unit 110 further stores records for later collection or analysis. These records may be collected after recording has ended or during a halt in operations. In some embodiments, the stored records for later retrieval may be un-filtered and un-stacked records.

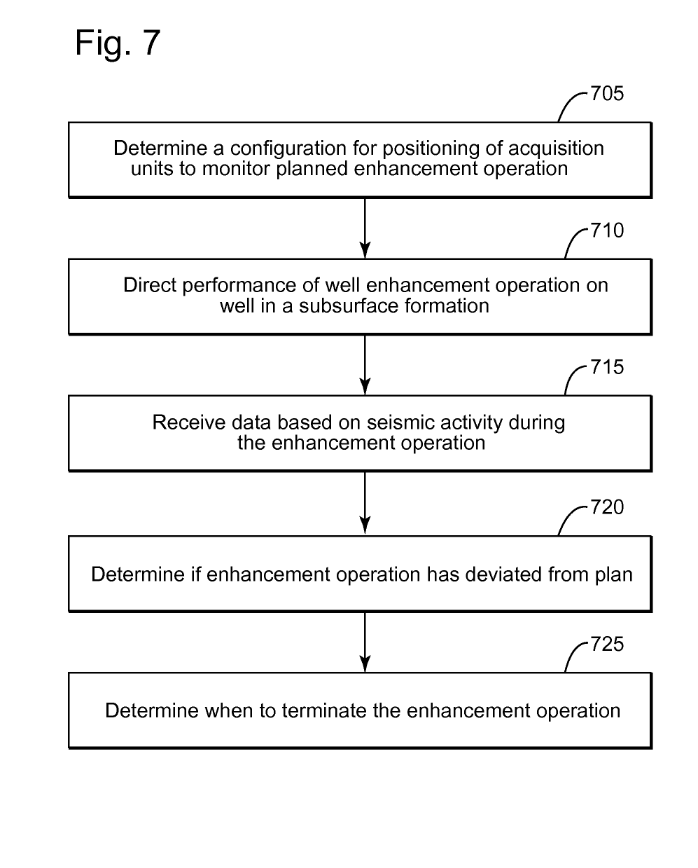

FIG. 7 illustrates a flow chart for example methods for monitoring a well enhancement operation. The steps of method 700 are performed by a user, various computer programs, models configured to detect, receive, process, and analyze seismic data, and combinations thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to detect, receive, process, and analyze seismic data may be referred to as a “computing system.” The computing system may include one or more of acquisition units 105, temporary data collection units 110, and central data collection unit 115 described with respect to FIGS. 1 through 4. Example embodiments may omit one or more of blocks 705 through 725. Other example embodiments may include additional steps. Still other embodiments may perform blocks 705 through 725 in a different order from that shown in FIG. 7

Example enhancement operations include hydraulic fracturing of a formation. Other operations that cause microseismic responses may also monitored by the systems and methods of the present disclosure. For example, drilling a well in a subsurface formation may be monitored by the systems and method of the present disclosure.

In block 705, a computing system determines a configuration for positioning of acquisition units 105 to monitor a planned well enhancement operation. In some embodiments, two or more patches of acquisition units 105 are positioned according to an expected extent and duration of a planned hydraulic fracturing operation. In some embodiments, acquisition units 105 are repositioned over the course of a well enhancement operation.

In block 710, the computing system directs performance of a well enhancement operation on the well in the subsurface formation. The well enhancement operation may generate seismic energy in the subsurface formation and therefore may be a passive seismic source. Example well enhancement operations include initiating a hydraulic fracturing operation.

In block 715, during the well enhancement operation, the computing system receives data based on seismic activity during the enhancement operation. For example, acquisition units 105 may transmit records of seismic activity to temporary data collection unit 110 based on defined time windows. Temporary data collection unit 110 may process the received records and transmit data to central data collection unit 115, which may be included in the computing system. Central data collection unit 115 performs analysis on the received records to evaluate the progress of the enhancement operation. Central data collection unit 115 may determine the actual extent and duration of a fracture initiated in the subsurface formation.

In block 720, the computing system determines if the enhancement operation has deviated from the planned enhancement operation. For example, central data collection unit 115 may determine if fracture propagation is deviating from the planned hydraulic fracturing operation. Example embodiments alter the enhancement operation based on the results of the determination of block 720. Example embodiments may alter a hydraulic fracturing operation, if central data collection unit 115 determines that the fracture is propagating in an unexpected manner.

In block 725, the computing system determines when to terminate the enhancement operation based, at least in part, on the received records of seismic activity. For example, analysis by central data collection unit 115 of the microseismic records from acquisition units 105 may show that a fracturing operation has reached an expected completion. Based on this information, the computing system or a user may terminate the hydraulic fracturing operation. In some embodiments, a user of the computing system and central data collection unit 115 recognizes that the enhancement operation is deviating from the planned operation and the user may choose to terminate the enhancement operation. In another example, the hydraulic fracturing operation is modified based on the analysis of the received records by central data collection unit 115.

Additionally, in some embodiments, central data collection unit 115 performs other data analysis based, at least in part, on the records of seismic activity received from acquisition units 105. For example, the central data collection unit 115 may perform other microseismic analysis based, at least in part, on the records received from acquisition units 105.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

It is understood that by programming or loading executable instructions onto the acquisition unit 105, temporary data collection unit 110, or central data collection unit 115 at least one of the processor 210 or memory 215 are changed, transforming the acquisition unit 105, temporary data collection unit 110, or central data collection unit 115 in part into a particular machine or apparatus having the functionality taught by the present disclosure. It is fundamental to the electrical engineering and software engineering arts that functionality that can be implemented by loading executable software into a computer can be converted to a hardware implementation by well-known design rules.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. In certain embodiments, the computer-readable medium may be non-transitory.

Embodiments of the disclosure may also relate to an apparatus for performing the operations herein. This apparatus may be specially constructed for the required purposes, or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The preceding detailed description does not limit the disclosure. Instead, the scope of the disclosure is defined by the appended claims. Some of the preceding embodiments are discussed, for simplicity, with regard to the terminology and structure of geologic surface reconstruction using implicit potential functions with a minimal bending energy concept. The embodiments, however, are not limited to these configurations, and may be extended to other arrangements.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate.

What is claimed is:

1. A data acquisition method for seismic exploration comprising:
generating a time reference for an acquisition unit, wherein the time reference defines a time window in the future;
transmitting the time reference to the acquisition unit; and
after the time window has elapsed, receiving a record of a seismic event measured during the time window.

2. The method of claim 1, wherein the seismic event is a passive seismic event.

3. The method of claim 1, wherein the seismic event is an active seismic event.

4. The method of claim 1, further comprising receiving a plurality of records from a plurality of acquisition units, wherein the plurality of records correspond to the time window.

5. The method of claim 4, further comprising transmitting at least part of the plurality of records to a central data collection unit.

6. The method of claim 4, further comprising stacking two or more of the plurality of records to create a stacked record associated with the time window.

7. The method of claim 6, further comprising transmitting at least part of the stacked record to a central data collection unit.

8. The method of claim 1, further comprising receiving output signals from one or more seismic receivers.

9. The method of claim 1, further comprising:
performing a fracturing operation on a subsurface formation; and
determining when to terminate the fracturing operation based, at least in part, on the record from the acquisition unit.

10. The method of claim 1, further comprising:
performing a fracturing operation on a subsurface formation; and
determining whether a fracture has deviated from a fracture plan based, at least in part, on the record from the acquisition unit.

11. An acquisition unit for seismic exploration comprising:
a seismic receiver configured to generate a signal in response to a sensed seismic event;
a processor;
a network interface;
a memory configured to store data based on the signal generated by the seismic receiver and store executable instructions that, when executed by the processor, cause the processor to:
receive a time reference, wherein the time reference defines a time window in the future;
measure a property associated with a seismic event during the time window to generate a record associated with the time window; and
transmit the record associated with the time window to a first data collection unit after the time window has elapsed.

12. The unit of claim 11, wherein the seismic receiver includes one or more seismic receivers selected from the group consisting of a hydrophone, a geophone, a 3C geophone, and a set of distributed acoustic sensors.

13. The unit of claim 11, further comprising a GPS receiver configured to determine a current time.

14. The unit of claim 11, wherein the network interface includes a wireless network interface and wherein the executable instructions further cause the processor to associate the acquisition unit with a first data collection unit.

15. A data acquisition system for seismic exploration, the system comprising:
a first data collection unit comprising:
a network interface;
a processor;
a memory, the memory comprising executable instructions that, when executed, cause the processor to:
generate a time reference for a first plurality of acquisition units, wherein the time reference defines a time window in the future;
transmit the time reference to the first plurality of acquisition units;
receive, from the first plurality of acquisition units, a plurality of records of a seismic event during the time window.

16. The system of claim 15, wherein the executable instructions further cause the processor to store data based, at least part, on the plurality of received records of the seismic event during the time window in the memory.

17. The system of claim 15, wherein the executable instructions further cause the processor to stack two or more of the plurality of received records, wherein the stacked records correspond to the time window.

18. The system of claim 15, wherein the executable instructions further cause the at least one processor to filter the plurality of received records, wherein the filtered records correspond to the time window.

19. The system of claim 15, the system further comprising:
a second data collection unit comprising:
a second network interface;
a second processor;
a second memory, the second memory comprising executable instructions that, when executed, cause the second processor to:
generate a time reference for a second plurality of acquisition units, wherein the time reference defines a time windows in the future;
transmit the time reference to the second plurality of acquisition units;
receive, from the second plurality of acquisition units, a plurality of records of a seismic event during the time window.

20. The system of claim 19, wherein the first data collection unit and the second data collection unit are connected by a mesh wireless network, and wherein the system further comprises:
a central data collection unit comprising:
a third network interface;
a third processor;
a third memory, the third memory comprising executable instructions that, when executed, cause the third processor to:
receive a plurality of records of seismic activity from the first data collection unit and the second data collection unit; and
determine when to terminate a hydraulic fracturing operation based, at least in part, on the plurality of received records of seismic activity from the first data collection unit and second data collection unit.
